(19) United States
(12) Patent Application Publication
(10) Pub. No.: US 2016/0321564 A1
(43) Pub. Date: Nov. 3, 2016

(54) OPERATIONAL PARAMETER VALUE LEARNING DEVICE, OPERATIONAL PARAMETER VALUE LEARNING METHOD, AND CONTROLLER FOR LEARNING DEVICE

(71) Applicant: KABUSHIKI KAISHA TOSHIBA, Tokyo (JP)

(72) Inventors: Shuichiro IMAHARA, Kawasaki (JP); Toru YANO, Tokyo (JP); Ryosuke TAKEUCHI, Tokyo (JP); Yoshiyuki SAKAMOTO, Toda (JP)

(21) Appl. No.: 15/211,422

(22) Filed: Jul. 15, 2016

Related U.S. Application Data
(63) Continuation of application No. PCT/JP2015/051216, filed on Jan. 19, 2015.

(30) Foreign Application Priority Data
Jan. 17, 2014 (JP) 2014-007065

(51) Int. Cl. G06N 99/00; G05B 13/02; F24F 11/00; G06N 7/00

(52) U.S. Cl. CPC G06N 99/005; G06N 7/005; G05B 13/0265; F24F 11/006

(57) ABSTRACT

An operational parameter value learning device according to one embodiment learns an operational parameter value of a device for each of users. A calculator is configured to calculate a duration time during which the device is estimated to have operated at each operational parameter value for each of the users based on history information including at least one of: behavior states of the users, an environmental state, and an operational state of the device. A selector is configured to calculate a continuation probability feature amount according to which the device continues an operation at each operational parameter value in each duration time for each of the users on a basis of the duration time calculated by calculator and selects the operational parameter value based on the calculated continuation probability feature amount.

### CROSS-REFERENCE TO RELATED APPLICATIONS

This application is a Continuation of International Application No. PCT/JP2015/051216, filed on Jan. 19, 2015, the entire contents of which is hereby incorporated by reference.

### FIELD

Embodiments described herein relate to an operational parameter value learning device, an operational parameter value learning method, and a control apparatus for a learning device.

### BACKGROUND

In the field of the smart house, technologies to improve the convenience of users by integrating in-house devices for automatic control are developed. In these technologies, a method to perform the automatic control based on predetermined control rules is generally used. However, since appropriate values of operational parameters such as temperature and illuminance used in the control rules differ among the users, the convenience for users may be lowered if a uniform value is set as the operational parameter value. Therefore, a method is proposed to learn control rules based on how users operate devices and implement the automatic control based on the learned control rules.

Conventionally, as a method of learning a control rule, a method is proposed to learn a control rule from regularity of external factors such as time, day, temperature and weather when a device is operated by a user. Under such technologies, since a new control rule is learned by finding the regularity of the various pieces of information, the flexibility of the learned control rule is high. However, since combinations of learnable control rules are various, there is a problem that an unexpected control rule for the user may be learned due to the regularity incidentally found in a small amount of data.

Moreover, when a device is operated by a plurality of users, an operational parameter felt comfortable may differ among the users and therefore it is difficult to learn an optimum control rule for all of the users.

### BRIEF DESCRIPTION OF THE DRAWINGS

FIG. 1 is a block diagram showing an example of a functional configuration of an operational parameter learning device;

FIGS. 2A to 2C are diagrams showing an example of history information according to an embodiment;

FIG. 3 is a diagram showing an example of applied conditions according to the embodiment;

FIG. 4 is a diagram showing an example of a processing-target operational parameter value according to the embodiment;

FIG. 5 is a diagram explaining a start determination according to the embodiment;

FIG. 6 is a diagram explaining the start determination according to the embodiment;

FIG. 7 is a diagram showing an example of end conditions according to the embodiment;

FIG. 8 is a diagram showing an example of duration time information according to the embodiment;

FIG. 9 is a diagram showing an example of a continuation probability feature amount according to the embodiment;

FIG. 10 is a diagram showing an example of select conditions according to the embodiment;

FIG. 11 is a diagram showing an example of configuration of an operational parameter value learning device according to the embodiment;

FIG. 12 is a flowchart showing a learning process of an operational parameter value learning device according to the embodiment;

FIG. 13 is a block diagram showing an example of functional configuration of an operational parameter value learning device in FIG. 1, comprising an operational parameter value notifier;

FIG. 14 is a block diagram showing an example of a functional configuration of a learning-type device controller;

FIG. 15 is a diagram showing an example of a control rule according to the embodiment;

FIG. 16 is a flowchart showing a learning process executed by the learning-type device controller according to the embodiment; and

FIG. 17 is a flowchart showing a control process executed by the learning-type device controller according to the embodiment.

### DETAILED DESCRIPTION

The operational parameter value learning device and the operational parameter value learning method are proposed which enable to learn an operational parameter value that make users feel less discomfort. Additionally, the learning-type device controller which enables to control a device by using the operational parameter value is proposed.

An operational parameter value learning device according to one embodiment learns an operational parameter value of a device for each of users. A calculator is configured to calculate a duration time during which the device is estimated to have operated at each operational parameter value for each of the users based on history information including at least one of: behavior states of the users, an environmental state, and an operational state of the device. The selector is configured to calculate a continuation probability feature amount according to which the device continues an operation at each operational parameter value in each duration time for each of the users on a basis of the duration time calculated by calculator and selects the operational parameter value based on the calculated continuation probability feature amount.

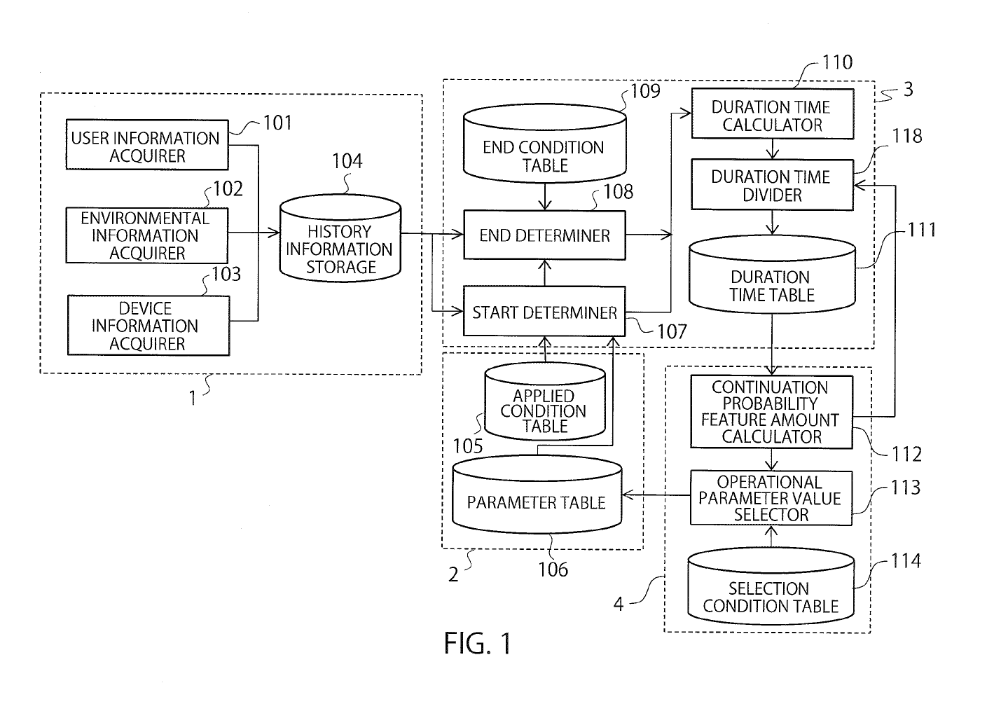

Hereinafter, an embodiment of the operational parameter value learning device (hereinafter referred to as “the learning device”) and the operational parameter value learning method (hereinafter, referred to as “the learning method”) will be described with reference to the FIG. 1 through FIG. 11. The learning device and the learning method according to the embodiment learn optimum operational parameter value of the device (hereinafter, referred to as “the target device”) for users. Although the target device is a heating device, a cooling device or a lightning device etc., the target device is not limited to the above. Operational parameters are various parameters settable when the target device is operated. For example, the operational parameters include a set temperature, an air volume and an air direction of a heating and cooling device, illuminance of a lightning device, and the like. The operational parameters are determined depending on the target device. The learning device can learn an optimum parameter value for users when the operational parameter of the target device can take plural values (the operational parameter values). In this specification, the optimum operational parameter value for users is the operational parameter value that makes the users feel less discomfort and satisfy a selecting condition discussed later. Hereinafter, a case where the target device is installed at home will be explained, but an installation place of the target device can be any places such as stores, offices, or commercial facilities, and the like.

FIG. 1 is a block diagram showing an example of a functional configuration of the learning device according to the embodiment. As shown in FIG. 1, the learning device includes an information acquirer 1 which acquires various pieces of information at home, a storage 2 in which applied conditions and operational parameter values are stored, a calculator 3 which calculates a duration time in which the target device operates by each of the operational parameter values, and a selector 4 which selects an optimum operational parameter value based on the duration time.

The information acquirer 1 acquires various pieces of information at home. As shown in FIG. 1, the information acquirer 1 includes a user information acquirer 101 which acquires user information, an environmental information acquirer 102 which acquires environmental information, a device information acquirer 103 which acquires device information and a history information storage 104 in which acquired information is stored.

The user information acquirer 101 acquires the user information at a predetermined time interval. The user information is information showing the behavior state of the user (such as residents or guests) of the target device at home. The user information includes information indicating that, for example, the user is in a room, out of a room (absent), in sleeping, in cooking and the like. Various sensors, such as a motion sensor, a temperature sensor and an illuminance sensor, can be used as the user information acquirer 101. The user information acquirer 101 sends the acquired user information to the history information storage 104.

The environmental information acquirer 102 acquires the environmental information at a predetermined time interval. The environmental information is information indicating the state of the environment at home. The environmental information includes information indicating that, for example, a temperature, humidity, and illuminance, and the like. Various sensors, such as a temperature sensor, a humidity sensor and an illuminance sensor, can be used as the environmental information acquirer 102. The environmental information acquirer 102 sends the acquired environmental information to the history information storage 104.

Incidentally, as the user information acquirer 101 and the environmental information acquirer 102 mentioned above, virtual sensors may be used to estimate and measure the behavior state of users and the environmental state, based on information acquired from one or several sensors and time information. Such virtual sensors include a sleeping sensor estimating whether the user is in sleep or not based on illuminance information and time information and a discomfort index sensor measuring a discomfort index based on temperature information and humidity information.

The device information acquirer 103 acquires the device information at a predetermined time interval. The device information is information indicating the state of the operation of the target device. The device information includes information indicating “under operation (ON)” and “under suspension (OFF)” and the operational parameter value under operation; for example, a set temperature, an air volume and an air direction of a heating and cooling device, illuminance of a lightning device, a state of an opening and closing of a blind and the like. Here, the device information may include information indicating the operational state of device(s) other than the target device.

For example, an external device acquiring the device information from the target device can be used as the device information acquirer 103. A configuration acquiring the device information directly from the target device is possible. In this case, a functional configuration of the device information acquirer 103 is implemented by a part of a function of the target device. The device information acquirer 103 sends the acquired device information to the history information storage 104.

The history information storage 104 acquires information at a predetermined time interval from the user information acquirer 101, the environmental information acquirer 102 and the device information acquirer 103 and stores the acquired information as history information therein.

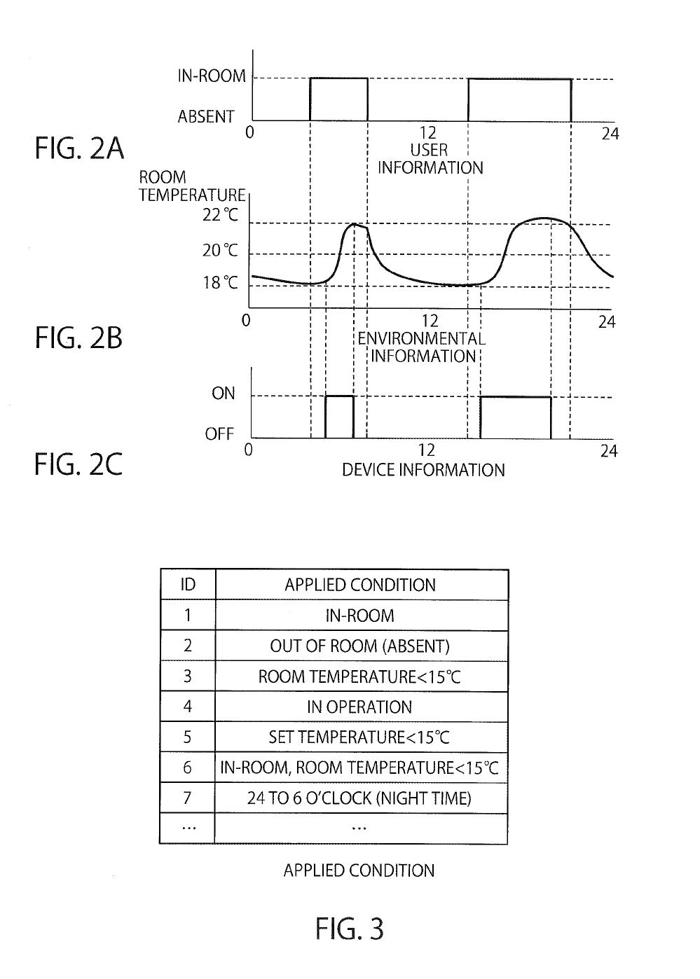

Here, FIG. 2 is a diagram showing an example of user information, environmental information and device information stored in the history information storage 104. FIG. 2A is an example of the user information, which shows an in-room status of user(s) in each time. FIG. 2B is an example of the environmental information, which shows a temperature in each time. FIG. 2C is an example of the device information, which shows an operation status (ON/OFF) of the target device at each time point.

An interpolation process, a smoothing process, an anomalous value removal process and the like may be applied to the history information stored in the history information storage 104. This makes it possible to precisely calculate the duration time and a continuation probability feature amount described later and then improves learning precision of the learning device.

Hereinafter, the user information, the environmental information and the device information stored in the history information storage 104 as history information are collectively called the history information. The history information storage 104 sends the stored history information in response to a request from the calculator 3 described later.

Incidentally, the information acquirer 1 may also acquire, for example, information showing an outside air temperature or weather besides the user information, the environmental information and the device information mentioned above, and store it in the history information storage 104. Furthermore, the learning device according to the embodiment may have a configuration not including the information acquirer 1. In this case, the learning device may acquire the history information such as the user information, the environmental information and the device information from an external database.

The storage 2 stores applied conditions and operational parameter values. As shown in FIG. 1, the storage 2 includes an applied condition table 105 and a parameter table 106.

The applied condition table 105 stores applied conditions. The applied conditions each are conditions specifying a range in which the leaning device learns the operational parameter value. The learning device according to the embodiment learns the operational parameter value when the history information stored in the history information storage 104 satisfies the applied condition.

The applied conditions are set based on at least one of the behavior state of users, the environmental state, the operational state of the target device, and the range of time. FIG. 3 is a diagram showing an example of applied conditions. As shown in FIG. 3, for example, based on the behavior state of user, the applied conditions such as in a room or out of a room (absent) can be set. More, based on the environmental state, the applied conditions such as the range of a room temperature or illuminance can be set and, based on the operational state of the target device, the applied condition such as “the target device being under operation” or the range of the operational parameter value of the target device can be also set. Additionally, one applied condition obtained by combining these applied conditions can be set. Further, additionally, based on the range of time, the applied condition such as night time or day time can be set. The applied condition table 105 sends the stored applied condition(s) in response to a request from the calculator 3.

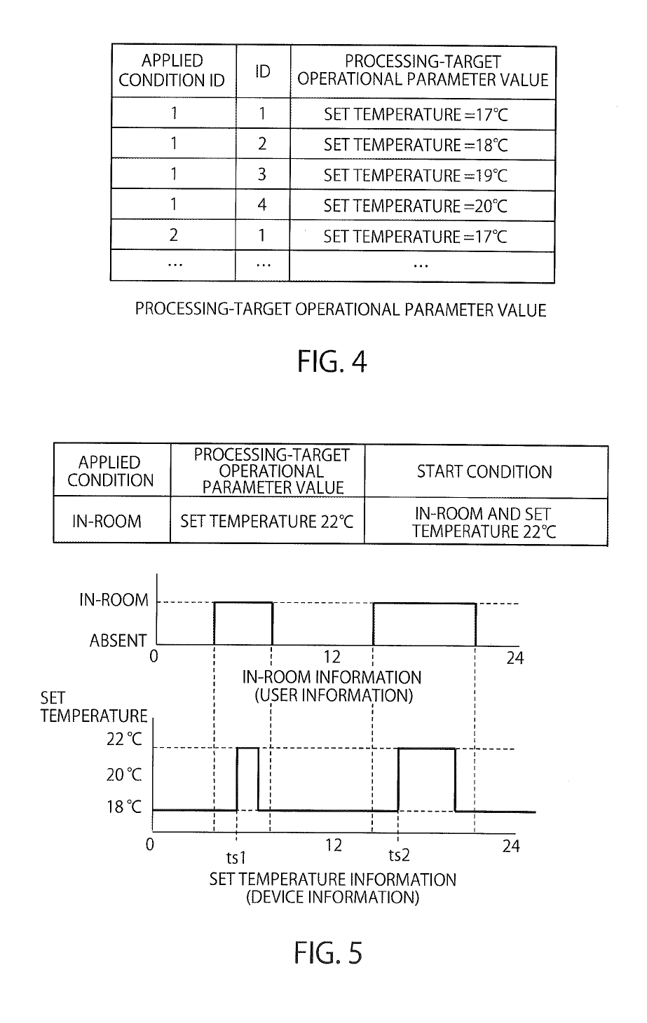

An operational parameter value table 106 stores a plurality of processing-target operational parameter values that become targets to calculate duration times by the calculator 3 described later for each applied condition. FIG. 4 is a diagram showing an example of processing-target operational parameter values stored in the operational parameter value table 106. In FIG. 4, the target device is a heating and cooling device and an operational parameter is a set temperature. The set temperatures are stored at an interval of a 1° C. as the processing-target operational parameter values. For example, the calculator 3 calculates the duration time(s) during which the heating and cooling device operates at set temperatures of 17° C., 18° C., 19° C. and 20° C., respectively, in a case of calculating the duration time(s) using the applied condition of ID1.

Incidentally, intervals of the set temperatures can be arbitrarily set such as 0.5° C. or 2° C. Furthermore, when the operational parameter is an air volume, it may store the air volume such as “low”, “medium”, or “high” as the processing-target operating parameter values.

An operational parameter value table 106 can also store operational parameter value selected by a selector 4 described later in association with the applied condition. The operational parameter value table 106 sends the stored applied condition in response to a request from the calculator 3.

The calculator 3 calculates the duration time(s) for each of the users. The duration time is a time that is estimated that the target device continues to operate at a certain operational parameter value. The calculator 3 calculates the duration time as the elapsed time from a start time at which the history information satisfies a start condition to an end time at which it satisfies an end condition. The calculator 3 acquires the history information of the predetermined learning period and calculates the duration times in the range where the history information satisfies the applied condition for each of the processing-target operational parameter values. The learning period can be arbitrarily set, for example, one day, one week, one month or the like. Additionally, the calculator 3 estimates the user(s) who operated the target device, and attaches the estimated user information to the duration times.

As shown in FIG. 1, the calculator 3 includes a start determiner 107 which determines whether the history information satisfies a start condition, an end determiner 108 which determines whether the history information satisfies the end condition, an end condition table 109 which stores the end condition, a duration time calculator 110 which calculates the duration time based on a start time and an end time, a duration time divider 118 which attaches user information to the duration times based on continuation probability feature amounts and a duration time table 111 which stores the duration times to which the user information are attached.

The start determiner 107 executes a start determination to determine whether the history information satisfies a start condition or not. The start condition is a condition to estimate that the target device started the operation at certain operational parameter, which is set based on the applied condition and the processing-target operational parameter value. The start determiner 107 executes the start determination for the history information in the ascending order of time, and acquires the start time being a time at which the history information changed from a state which does not satisfy the start condition to a state which satisfies the start condition. The start determiner 107 sends the acquired start time, the applied condition and the operational parameter value to the end determiner 108 and the duration time calculator 110. The start time acquired by the start determiner 107 becomes a starting point of the duration time.

FIG. 5 is a diagram showing an example of the history information, the applied condition and the processing-target operational parameter value acquired by the start determiner 107. In FIG. 5, the target device is a heating device: the learning period is 24 hours; the applied condition is present in room; and the processing-target operational parameter value is the set temperature 22° C. Moreover, the start determiner 107 acquires in-room information (user information) indicating the in-room status of user(s) and set temperature information (device information) indicating a set temperature of a heating device.

In this case, the start determiner 107 can execute the start determination by using the start condition that the history information simultaneously satisfies the applied condition and the processing-target operational parameter value. That is to say, it becomes the start condition that the user is present in room and that the heating device operates at the set temperature of 22° C. When the start condition is set, the start determiner 107 can easily execute the start determination because it can directly determine whether the history information satisfies the above-mentioned start condition or not. Specifically, the start determiner 107 may refer to the history information in the ascending order, determine whether the in-room information indicates in-room and determine whether the set temperature information is 22° C. By this start determination, the start determiner 107 can acquire times ts1 and ts2 as start times. As shown in FIG. 5, the times ts1 and ts2 are times that the history information (the set temperature information) has changed from the status which does not satisfy the start condition (18° C.) to the status which satisfies the start condition (22° C.), the history information being referred in the ascending order.

Incidentally, as mentioned above, when a plurality of start times exist, the start determiner 107 may collectively acquire the start times in the learning period. Furthermore, the start determiner 107 may acquire the start times one by one and, after calculating the duration time for the acquired start time, acquire the next start time.

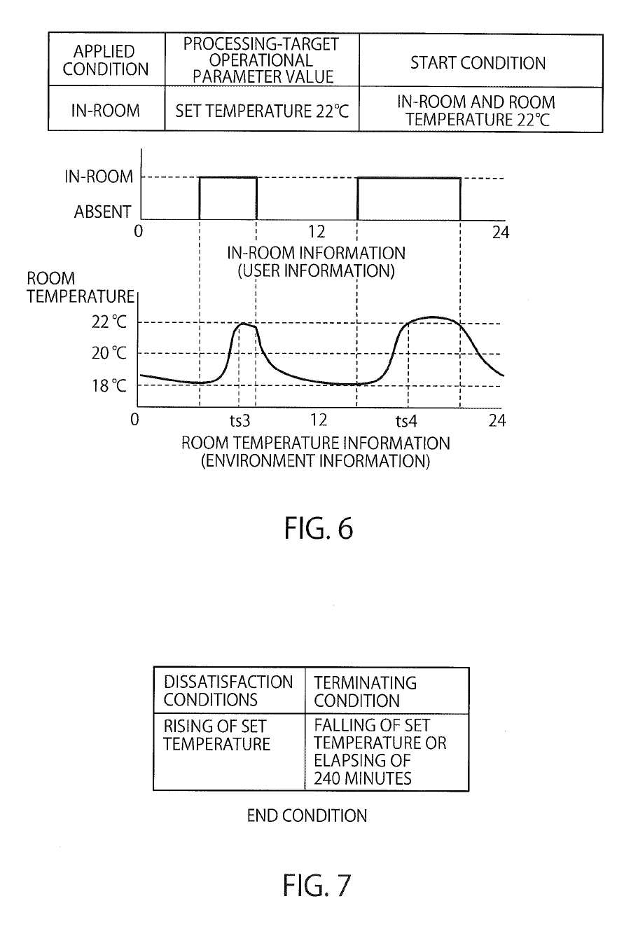

FIG. 6 is a diagram showing other examples of history information, the applied condition and the processing-target operational parameter value acquired by the start determiner 107. In FIG. 6, it differs from FIG. 5 in that the start determiner 107 acquires the room temperature information (the environmental information) instead of the set temperature information.

In the case of FIG. 6, the start determiner 107 is not able to execute a start determination using the same start condition as the case of FIG. 5. The reason is that the start determiner 107 can is able to determine whether the applied condition (present in room) is satisfied by referring to the in-room information, but it is not able to determine whether the target device operates at the set temperature of 22° C. even if it refers to the room temperature information. In such a case, the start determiner 107 can use, for example, that the user is in room and the room temperature is set at 22° C., as the start condition. That is because, if the room temperature is 22° C., it is estimated that a heating device operates at the set temperature of 22° C.

When using the start condition, the start determiner 107 executes the start determination by referring to the history information in the ascending order, determines whether the in-room information becomes in-room and determines whether the room temperature information shows 22° C. By this start determination, the start determiner 107 can acquire times ts3 and ts4 as start times. As shown in FIG. 6, the times ts3, ts4 are times that the history information changed from the status which does not satisfy the start condition to the status which satisfies the start condition: that is to say, times that the room temperature information changed from a value less than 22° C. to 22° C., where the history information were referred in the ascending order.

The start condition is arbitrarily configurable based on the applied condition and the processing-target operational parameter value as long as it is the condition which is configured to be able to estimate that the target device started operation based on the processing-target operational parameter value. The start determiner 107 may use such a condition as “the room temperature is continuously 22° C. during a predetermined time” as the start condition other than the aforementioned start condition. This enables to exclude the transient change of a room temperature and to estimate more precisely that a heating device operates at the set temperature of 22° C. In this case, the start determiner 107 acquires the time after a predetermined time elapsed from the times ts3 and ts4 as the start time.

The end determiner 108 executes the end determination to determine whether the history information satisfies the end condition or not. The end condition is a condition to estimate that the target device terminated its operation at one operational parameter value. The end determiner 108 executes the end determination on the history information, after the start time, in the ascending order and acquires the time at which the history information becomes the state which satisfies the end condition from the state which does not satisfy the end condition as the end time. The end determiner 108 sends the acquired end time to the duration time calculator 110. The end time acquired by the end determiner 108 becomes an ending point of the duration time.

Here, FIG. 7 is a diagram showing an example of the end condition stored in an end condition table 109. As shown in FIG. 7, the end condition is configured by including a dissatisfaction condition and a terminating condition.

The dissatisfaction condition (a first end condition) is a condition to determine that the user feel dissatisfaction on the processing-target operational parameter value. The dissatisfaction condition includes “the operational parameter value changes so as to improve availability of the target device”. Specifically, it includes a rise of a set temperature of a heating device, a fall of a set temperature of a cooling device, strengthening an air volume of a heating and cooling device and a rise of illuminance of a lightning device.

For example, in the history information of a heating device, in a case where a set temperature rises after a start time, it is considered that the user felt cold (dissatisfaction) at the original set temperature (the operational parameter value) and changed the set temperature to feel warm (to improve availability). Thus, it is considered that the user feels dissatisfaction on the processing-target parameter when the history information satisfies the dissatisfaction condition.

On the contrary, the terminating condition (the second end condition) is a condition for determining that the user do not feel huge dissatisfaction or satisfy on the processing-target operational parameter value. The terminating condition includes “the operational parameter value change to lower the availability of the target device”. Specifically, it includes a fall of a set temperature of a heating device, a rise of a set temperature of a cooling device, weakening an air volume of a heating and cooling device, and a fall of illuminance of a lightning device.

For example, in the history information of a heating device, in a case where a set temperature falls after a start time, it is considered that the user do not feel cold (dissatisfaction) at the original set temperature (the operational parameter value).

Furthermore, the terminating condition includes “threshold time elapses after the start time”. The threshold time is arbitrarily settable, and in FIG. 7, it is set to 240 minutes. For example, in the history information of a heating device, in a case where a set temperature is maintained during 240 minutes after a start time, it is considered that the user do not feel dissatisfaction or satisfy to the original set temperature (the operational parameter value). That is to say, when the history information satisfies the termination condition, it is considered that the user do not feel huge dissatisfaction or satisfy to the processing-target parameter.

The duration time calculator 110 calculates the duration time based on the start time acquired from the start determiner 107 and the end time acquired from the end determiner 108. The duration time calculator 110 can calculate the duration time by subtracting the start time from the end time. The duration time calculator 110 sends the calculated duration time, the applied condition, the processing-target operational parameter value and the end condition (the dissatisfaction condition or the terminating condition) to the duration time divider 118 and the duration time table 111.

The duration time divider 118, based on the continuation probability feature amount acquired from a continuation probability feature amount calculator 112, divides a plurality of the duration times acquired from the duration time calculator 110 into a plurality of sets and allocates each duration time to one of the users. For example, when the duration time divider 118 acquires 10 duration times from the continuation probability feature amount calculator 112, it divides into 3 duration times for allocating user A and 7 duration times for allocating user B. Then, the duration time divider 118 sends the user information allocated to each duration time to the duration time table 111. Thereby, the user information is added to each duration time. The user information added to each duration time includes information identifying a user (user ID, etc.).

The feature amount calculator 112 can calculate the continuation probability feature amount of each of the users by adding the user information to the duration time. Furthermore, an operational parameter value selector 113 becomes be able to select an operational parameter value for which the continuation probability feature amount of each of the users is taken into consideration.

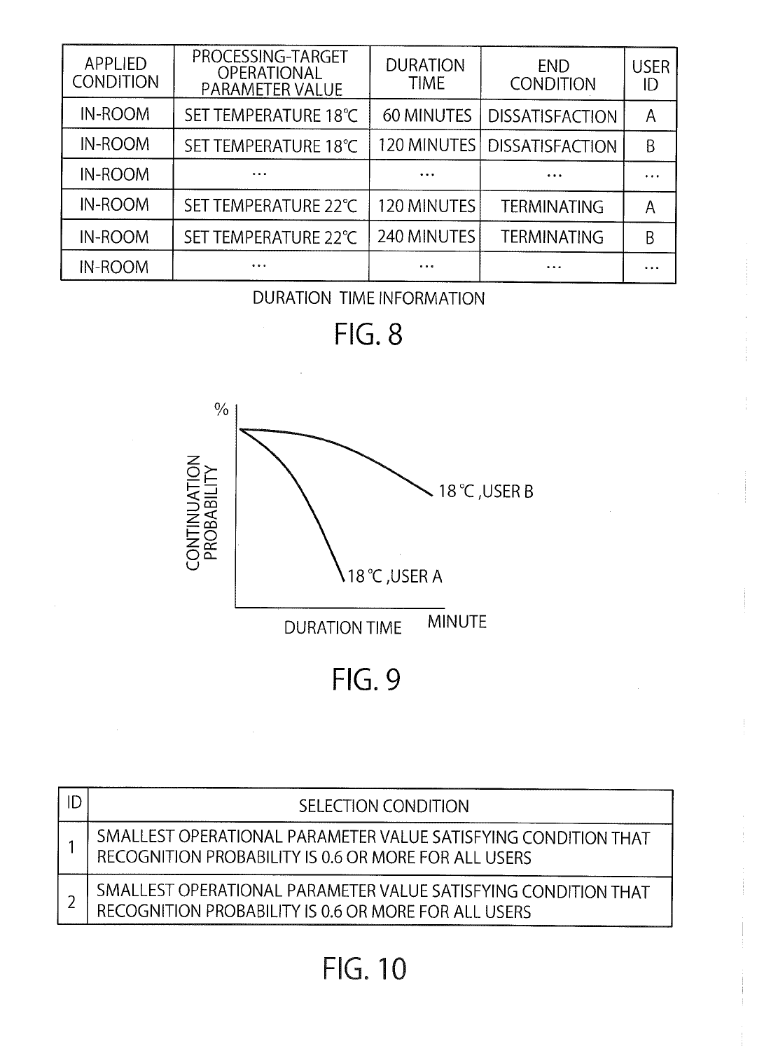

The duration time table 111 stores the applied conditions, the processing-target operational parameter values, the duration times, the end conditions (the dissatisfaction conditions or the terminating conditions) and the user information, which are acquired from the duration time calculator 110 and the duration time divider 118, in association with one another as the duration time information. FIG. 8 is a diagram showing an example of duration time information stored in the duration time table 111. In FIG. 8, the target device is a heating device: the operational parameter is a set temperature; and the user information is the user ID. The duration time table 111 sends the duration time information in response to the request from the selector 4.

The selector 4 calculates the continuation probability feature amount based on the duration time calculated by the calculator 3 and selects the optimum operational parameter value for each of the users based on the calculated continuation probability feature amount. As shown in FIG. 1, the selector 4 includes the continuation probability feature amount calculator 112 which calculates the continuation probability feature amount, the operational parameter value selector 113 which selects the optimum operational parameter value and a selection condition table 114 in which selecting condition(s) are stored.

The continuation probability feature amount calculator 112, based on the duration time information acquired from the duration time table 111, calculates the continuation probability feature amount for each of the process-target operational parameter values and for each of the users. The continuation probability feature amount is the feature amount that represents a curve showing the transition of the probability that the target device continues the operation at the processing-target operational parameter value in each duration time. It is, for example, is continuation probabilities of all times or is a parameter obtained when fitting a curve to a probability distribution.

FIG. 9 is a diagram showing an example of the continuation probability feature amount. In FIG. 9, the continuation probability feature amount is a continuation probability. A continuation probability of a set temperature of 18° C. of user A and a continuation probability of a set temperature of 18° C. of user B are shown.

The continuation probability feature amount calculator 112, for example, assumes a mixed sum of Weibull distribution (a probability distribution) to the survival function in the survival time analysis and can calculate the continuation probability feature amount by estimating a parameter of a probability distribution in a maximum likelihood method. When the mixed-Weibull distribution is assumed, it can calculate a scale parameter and a shape parameter by each of the users. The continuation probability feature amount calculator 112 outputs the set of these values for each of the users as the continuation probability feature amount.

In addition, the continuation probability feature amount calculator 112 calculates likelihood for each of users allocated each duration time based on the calculated continuous feature amount. After that, the division of the duration times and the allocation of users by the duration time divider 118 and the calculation of the continuation probability feature amounts and the likelihood by the continuation probability feature amount calculator 112 are repeated.

The continuation probability feature amount calculator 112 repeats the above process until the change of likelihood becomes the predetermined threshold value or less, sends the continuous feature amount at the end of the process to the operational parameter value selector 113. Here, a number of times by which the above process is carried out may be set.

The operational parameter value selector 113 selects the optimum operational parameter value by acquiring the continuation probability feature amount from the continuation probability feature amount calculator 112, acquiring the selection condition of the operational parameter value from the selection condition table 114, and comparing the continuation probability feature amount with the selection condition.

FIG. 10 is a diagram showing an example of selection conditions stored in the selection condition table 114. FIG. 10 shows the selection conditions that are set for the continuous feature amount in FIG. 9. The selecting condition in FIG. 10 is a condition to select the smallest among the operational parameter values (the set temperatures) satisfying the condition that the recognition probability obtained by using the continuous feature amounts as an input and calculating the recognition scheme such as Support Vector Machine is 0.6 or more. Here, the recognition probability is the probability that the user feels satisfied or do not feel dissatisfaction, which is calculated based on the continuous feature amounts of the user.

For example, when the set temperature of 20° C. satisfies that the recognition probability is 0.6 or more for both user A and user B: the set temperature of 19° C. satisfies that the recognition probability is 0.6 or more for both user A and user B; and the set temperature 18° C. is that the recognition probability is less than 0.6 for user A and 0.6 or more for user B, the set temperature satisfying the selection condition is 19° C. Therefore, the operational parameter value selector 113 selects 19° C. as the optimum set temperature.

Such selection enables to select the operational parameter value in which all of the users feel less dissatisfaction. Furthermore, as above, with using the recognition probability and other condition together, it can select the operational parameter value of smallest power consumption among the operational parameter values in which the users feel less dissatisfaction. Incidentally, upon using the recognition scheme such as Support Vector Machine, it may previously learn parameters of the recognition scheme by using correct data.

The operational parameter value selector 113 sends the optimum operational parameter value, the applied condition and the user information as selected above to the operational parameter value table 116. The operational parameter value table 106 stores the selected optimum operational parameter value, the selected applied condition and the selected user information in association with one another.

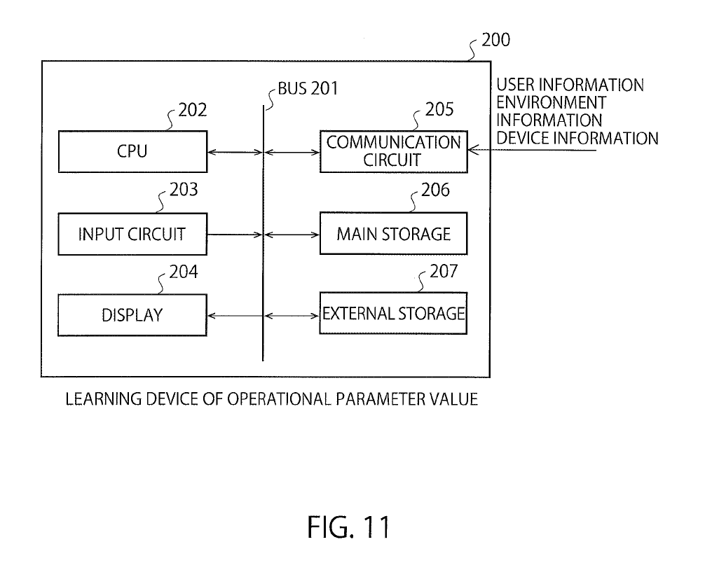

The functional configuration of the learning device can be implemented, for example, by using a general computing device 200 as basic hardware. As shown in FIG. 11, a general computing device 200 includes a CPU 202, an input circuit 203, a display 204, a communication circuit 205, a main storage 206 and an external storage 207, and these elements are mutually connected by a bus 201.

The input circuit 203 includes an inputting device such as a keyboard and a mouse, and outputs an operation signal by an operation of the inputting devices, to the CPU 202.

The display 204 includes a display such as an LCD (Liquid Crystal Display) or a CRT (Cathode Ray Tube).

The communication circuit 205 performs communication of scheme such as Ethernet®, wireless LAN (Local Area Network) or Bluetooth®. The communication circuit 205 communicates with the user information acquirer 101, the environmental information acquirer 102 and the device information acquirer 103 and acquires user information, environmental information and device information. Thereby, in FIG. 11, the user information acquirer 101, the environmental information acquirer 102 and the device information acquirer 103 are provided in external devices.

The external storage 207 is constituted by a storage medium such as a hard disk, a CD-R, a CD-RW, a DVD-RAM or a DVD-R, and the like. In the external storage 207, a control program is stored to cause the CPU 202 to execute the processing of the start determiner 107, the end determiner 108, the duration time calculator 110, the continuation probability calculator 112 and the operational parameter value selector 113.

The main storage 206 is constituted by a memory and the like. The main storage 206 develops the control program stored in the eternal storage 207 and stores data necessary at the time of execution of the program, data generated by execution of the program, and the like, under the control by the CPU 202.

The learning device may be implemented by previously installing the control program on the computing device. The learning device may be also implemented by appropriately installing the control program that is stored in a storage medium such as a CD-ROM or is distributed via a network, on the computing device 200.

The history information storage 104, the applied condition table 105, the operational parameter value table 106, the end condition table 109, the duration time table 111 and the selection table 114 are able to be implemented by appropriately using a storage medium such as the main storage 206 or external storage 207 that are incorporated in or externally attached to the above computing device 200.

Other than the above-described constituent elements, a printer of information such as the calculated continuation probability or the selected operational parameter values, and the like, may be included in the learning device. The configuration of the learning device shown in FIG. 11 may be modified depending on a target device from which the history information is collected.

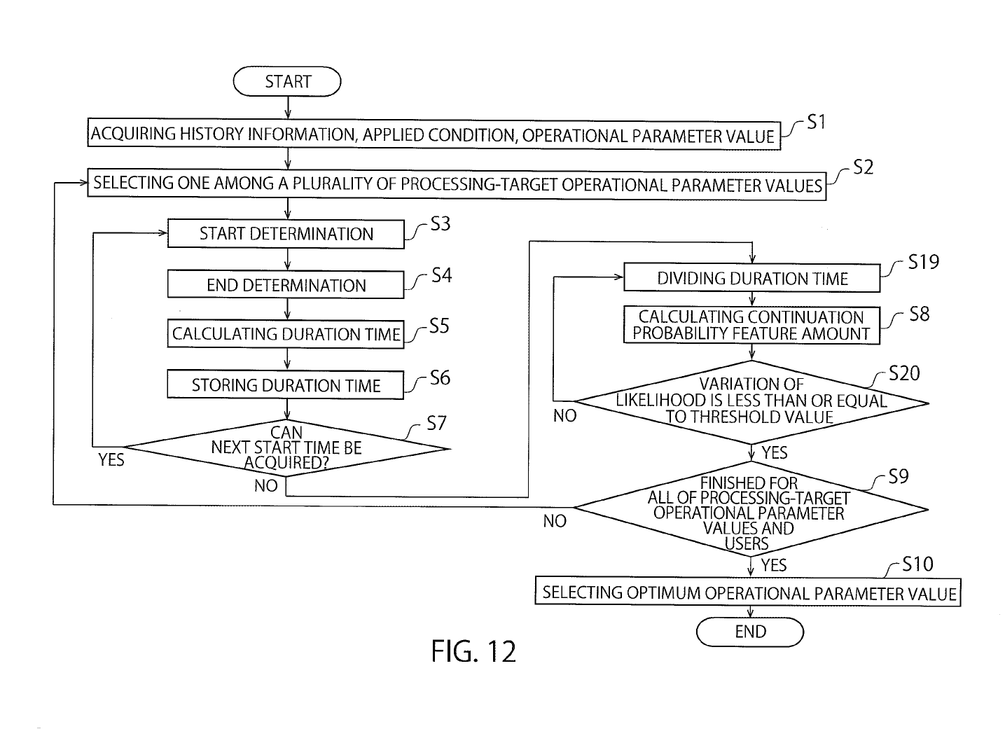

Next, the operation of the leaning device according to the embodiment will be described with reference to FIG. 12. FIG. 12 is a flowchart showing learning processing by the learning device according to the embodiment. As shown in FIG. 12, once the learning processing starts, the start determiner 107 first acquires history information of a learning period from the information acquirer 1, the applied condition that is a leaning target from the applied condition table 105 and the processing-target operational parameter values corresponding to the applied condition from the operational parameter value table 106 (step S1).

The start determiner 107, upon acquiring the history information, the applied condition and the processing-target operational parameter values, selects one processing-target operational parameter value among the processing-target operational parameter values (step S2). Next, the start determiner 107 refers to the history information from the starting point of the learning period in the ascending order of time and executes start determination based on the applied condition and the selected processing-target operational parameter value (step S3). The start determiner 107 acquires the first start time according to the start determination and sends the start time, the applied condition, and the processing-target operational parameter value to the end determiner 108 and the duration time calculator 110.

The end determiner 108, upon acquiring the first start time from the start determiner 107, refers to the history information after this start time, executes the end determination based on the end condition (step S4) and acquires the end time corresponding to the first start time. The end determiner 108 sends the acquired end time and the acquired end condition (the dissatisfaction condition or the terminating condition) to the duration time calculator 110.

The duration time calculator 110 calculates the duration time by subtracting the start time acquired from the start determiner 107 from the end time acquired from the end determiner 108 (step S5). The duration time calculator 110 sends the duration time, the applied condition, the operational parameter value and the end condition to the duration time divider 118 and the duration time table 111.

The duration time table 111 associates the applied condition, the duration time, the operational parameter value and the end condition acquired from the duration time calculator 110 with one another, and stores as duration time information (step S6). Once the duration time table 111 stores the duration time information, the start determiner 107 refers to the history information after the end time acquired in step S4 and executes the start determination again. The processes of the above steps S3 through S6 are repeated when the next start time is acquired by the start determiner 107 (Yes in step S7).

On the contrary, when the next start time is not acquired by the start determiner 107 (No in step S7), the duration time divider 118 divides a plurality of the duration times acquired from the continuation probability feature amount calculator 112 and allocates the users to the duration times divided (step S19). The user information of users allocated by the duration time divider 118 is stored in the duration time table 111.

In the case of the first division, the duration time divider 118 may divide the duration times in a random order and allocate users in a random order. Furthermore, in the case after the second division, the duration time divider 118 may execute the division and the allocation in a random order or execute the division and the allocation according to the likelihoods calculated based on the duration time feature amounts.

The continuation probability feature amount calculator 112 calculates the continuation probability feature amounts based on the duration time information stored in the duration time table 111 by then (step S8). The continuation probability calculator 112 acquires all of the duration time information of the processing-target operational parameter value selected in step S2 from the duration time table 111 or at least part of them and calculates the continuation probability feature amounts. Furthermore, the continuation probability feature amount calculator 12 calculates likelihoods of allocation of users based on the calculated continuation probability feature amounts. Likelihoods of the mixed-Weibull distribution can be calculated as the likelihoods of allocation of users.

The continuation probability feature amount calculator 112 compares the previously calculated likelihood with newly calculated likelihood (step S20). When a variation of likelihood is greater than a threshold value (No in step S20) or calculation of likelihood is for the first time, the process returns to step S19.

On the other hand, when a variation of likelihood is less than or equal to a threshold value (Yes in step S20), the continuation probability feature amount calculator 112 sends the calculated continuation probability feature amount to the operational parameter value selector 113 and the process proceeds to step S9.

When the continuation probability feature amount is calculated by the continuation probability feature amount calculator 112, the start determiner 107 determines whether the process finished for all of the processing-target operational parameter values and users acquired from the operational parameter value table 106 (step S9). In case of existing unprocessed operational parameter value or user (No in step S9), the process of the above steps S2 through S8 is repeated.

On the contrary, when calculation of the continuation probability feature amounts for all of the processing-target operational parameter values and users finished (Yes in step S9), the operational parameter value selector 113 acquires the continuation probability feature amount of each of the operational parameter values from the continuation probability feature amount calculator 112 and the selecting condition from the selection condition table 114. The operational parameter value selector 113 compares the continuous probability feature amount to the selection condition for each of the calculated processing-target operational parameter values and selects the optimum operational parameter value (step S10). The selected operating parameter value is stored in the operational parameter value table 106 associated with the applied condition.

Incidentally, in the above learning processes, the order of the processes may be reversed between step S19, S8 and S20 and step S9. In this case, the duration time information of a plurality of operational parameter values are stored in the duration time table 111. The continuation probability feature amount calculator 112 may acquire the duration time information of a plurality of operational parameter values and calculate the continuation probability feature amount for each of the operational parameter values. Additionally, the start determiner 107 acquires the start times one by one and acquires the next start time after the duration time to the acquired start time is calculated, but it may collectively acquire the start times in the learning period. Furthermore, step S20 may be omitted.

As explained above, according to the learning device and learning method in the embodiment, it can learn the operational parameter value at which recognition probability for each of the users is higher than the recognition probability set in the selection condition. Therefore, according to the learning device in the embodiment, it can learn the operational parameter value in which all of the users feel less dissatisfaction even though the target device is used by a plurality of users.

In addition, since the learning device according to the embodiment can learn the smallest power-consumption operational parameter value and the like among the operational parameter values in which users feel less dissatisfaction, it can learn the optimum operational parameter value for all of the users.

Furthermore, the leaning device according to the embodiment can learn the optimum operational parameter value in various situations by changing the applied condition. For example, when a target device is a heating and cooling device, it can learn the optimum set temperature, air volume and air direction for each room temperature or humidity.

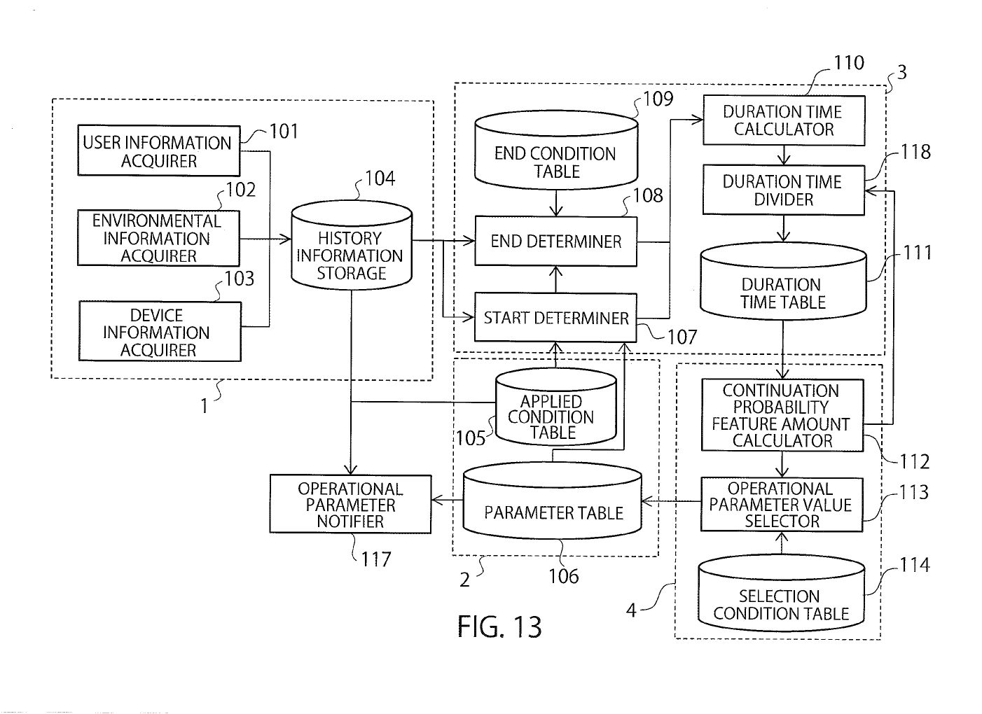

FIG. 13 is a block diagram showing a functional configuration of the operational parameter value leaning device, according to the embodiment, which additionally include the operational parameter notifier 117. The operational parameter value learning device can be used as the operational parameter value notification device which notifies the optimum operating parameter value learned by the operational parameter value learning device to the users.

The operational parameter notifier 117 notifies the optimum operational parameter value selected by the selector 4 to the users. The operational parameter notifier 117 acquires the current history information or the nearest predetermined period of history information from the history information storage 104, and the applied condition from the applied condition table 105. The operational parameter notifier 117 determines whether the history information satisfies the applied condition by comparing the acquired history information to the acquired applied condition, and when it determines the applied condition is satisfied, it acquires the optimum operational parameter value corresponding to the applied condition from the operational parameter value table 106 and notifies to users. Output devices such as a display including image output function or a speaker including sound output function, and the like, can be used as the operational parameter notifier 117.

By controlling the device in accordance with the operating parameter value notified from the operational parameter notifier 117, the users can enjoy a merit of construction of comfortable environment or reduction of power consumption, and the like.

### The Second Embodiment

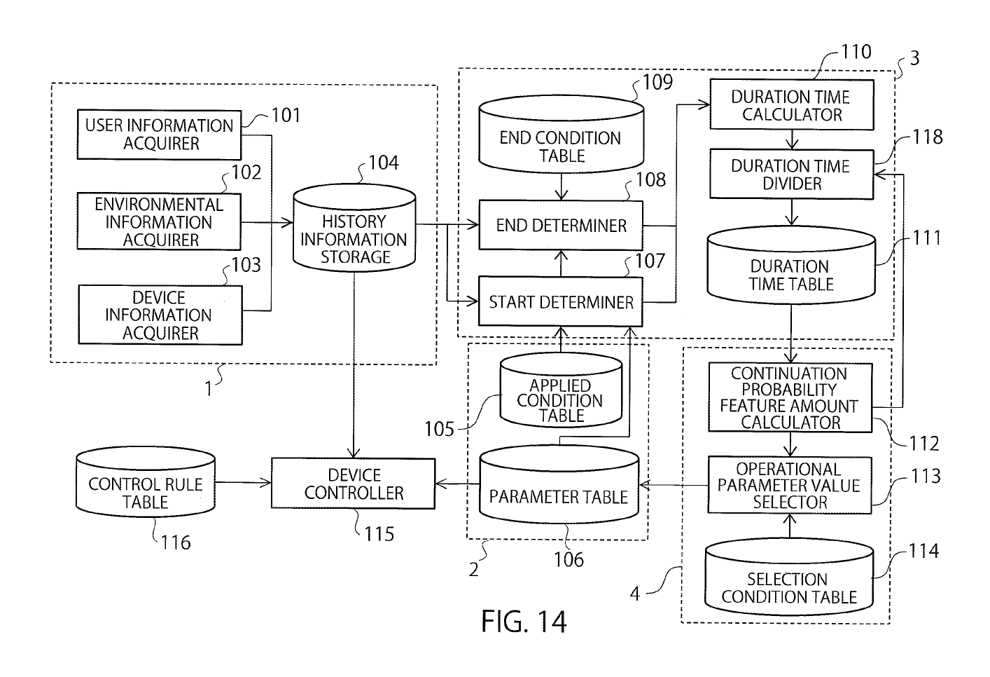

Next, the embodiment of learning-type device controller (hereinafter referred to as “the controller”) will be described with reference to the FIG. 14 through FIG. 17. The controller according to the embodiment controls an operational parameter of a target device that is installed at such as home, stores, offices, or commercial facilities, and the like in accordance with a control rule preset. The controller according to the embodiment controls the target device by using the optimum operational parameter value that is learned by the learning device according to the first embodiment.

Here, FIG. 14 is a block diagram showing a functional configuration of the controller according to the embodiment. As shown in FIG. 14, the controller includes the information acquirer 1, the storage 2, the calculator 3 and the selector 4. This configuration is similar to the learning device according to the first embodiment. The controller according to the embodiment, additionally, includes a device controller 115 which controls the target device and a control rule table 116 in which control rules are stored.

A device controller 115 (controller) controls the target device in accordance with the preset control rule(s). The device controller 115 acquires the current (latest) history information or the nearest predetermined period of history information from the history information storage 114, the control rule(s) from the control rule table 116 and optimum operational parameter value from the operational parameter value table 106. The device controller 115 compares the current history information to the control rules and selects the control rule to start controlling of the target device.

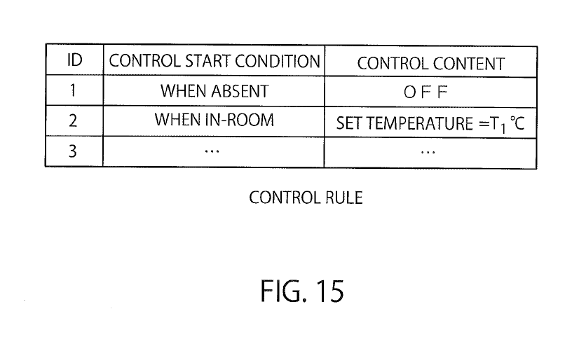

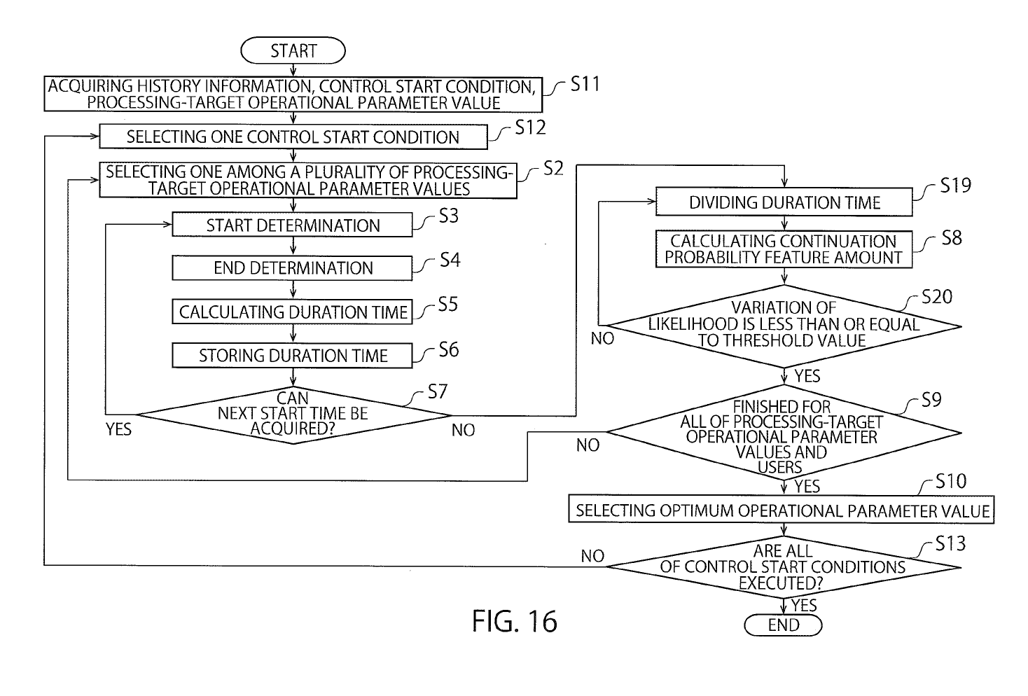

FIG. 15 is a diagram showing an example of the control rules stored in a control rule table when the target device is a heating device. As shown in FIG. 15, each control rule is constituted by a control start condition and control content. The control start condition is a condition for determining whether to start controlling of the target device in accordance with the control rule. The device controller 115 compares the current history information to the control start condition, and when the current history information satisfies the control start condition, it starts controlling the target device by the control rule. The control start condition is set based on at least one of the behavior state of users, the environmental state and the operational state of the device. The control content is a substance of control that the device controller 115 makes the target device execute when the current history information satisfies the control start condition.

For example, the control rule of ID1 shown in FIG. 15 is that the control start condition is “absence” and that the control content is “OFF” of a heating device (suspension). That is to say, the device controller 115, once the user who was present in room becomes absent, starts control by the control rule of ID1 and makes operation of a heating device stop.

On the contrary, the control rule of ID2 shown in FIG. 15 corresponds to control start condition being present in room and the control content being set temperature T1° C. That is to say, the device controller 115, once the user who is absent become present in room, starts control by the control rule of ID2 and makes a heating device operate at a set temperature of T1° C. Here, the control content of the control rule of ID2 have been set up using the operational parameter value (set temperature) of a heating device and the operational parameter value is represented by a variable T1. In such a case, the device controller 116, as the operational parameter value T1, acquires the optimum operational parameter value stored in the operational parameter value table 106 and controls the target device using the acquired operational parameter value.

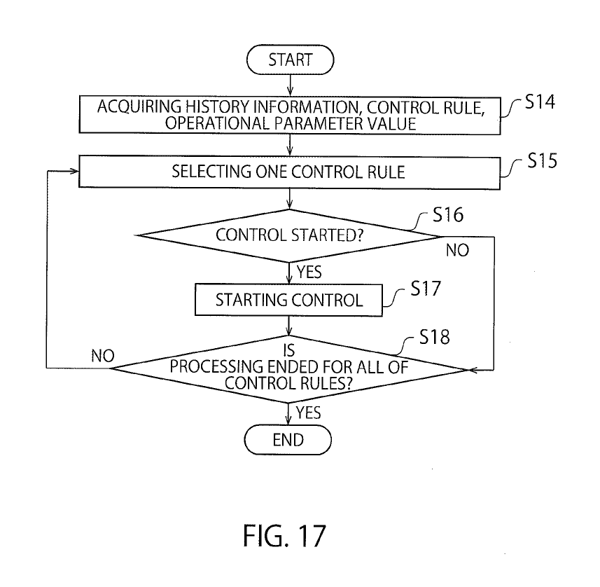

Next, the operation of the controller according to the embodiment will be described with reference to the FIG. 16 and FIG. 17. FIG. 16 is a flowchart showing learning processing of the controller of the embodiment. As shown in FIG. 16, the start determiner 107 first acquires history information of a learning period, control start conditions and a processing-target operational parameter value (step S11).

The start determiner 107 may acquire the control start conditions from the control rule table 116. In this case, the controller may be able to have the configuration not including the applied condition table 105. Furthermore, when the control start condition is stored beforehand as the applied condition in the applied condition table 105, the start determiner 107 may acquire the control start condition from the applied condition table 105. In either case, the start determiner 107, as in the aforementioned control rules of ID2, may acquire the control start condition of the control rule in which the control content is set by operational parameter value and, as in the aforementioned control rule of ID1, may not acquire the control start condition of the control rule in which the control contents is not set by the operational parameter value.

In addition, the start determiner 107 acquires the process-target operational parameter value stored the operational parameter value table 106 for each of the control start conditions. The processing-target operating parameter value of each of the control start conditions may be stored beforehand in the operational parameter value table 106. Then, the start determiner 107 selects one control start condition for which the learning process is first executed (step S12).

The subsequent learning processes are similar to step S2 through step S10 of the learning processes of the leaning device according to the first embodiment (see FIG. 12). Thus, the start determiner 107 selects one processing-target operating parameter value (step S2), executes the start determination to acquire the start time (step S3). The end determiner 108 executes the end determination to acquire the end time corresponding to the start time acquired by the start determiner 107 and the end condition (step S4). The duration time calculator 110 calculates the duration time based on the start time and the end time (step S5). The duration time table 111 stores the duration time information (step S6). After processes of the above step S2 through step S6 are repeated until the start determiner 107 cannot acquire any start time (step S7), the continuation probability feature amount calculator 112 calculates the continuation probability feature amount (step S8). The processes of the above step S2 through step S8 are executed to all of the processing-target operating parameter values (step S9). Once the continuation probability feature amounts to all of the processing-target operating parameter values is calculated, the operating parameter value selector 113 selects the optimum operating parameter value based on the selection condition (step S10). At the time step S10 is completed, the selection of the optimum operating parameter value to the control rule including the control start condition selected in step S11 is completed. The selected optimum operating parameter value is stored in the operating parameter value table 106 in association with the control start condition.

The processes of the above step S2 through step S10 are executed to all of the control start conditions (step S13). Thereby, the optimum operating parameter values are selected to all of control rules and stored in the operating parameter value table 106. The controller can update the optimum operating parameter values by executing the learning processes in at an arbitrary interval of an hour, one day, one week, or the like.

FIG. 17 is a flowchart showing control processing of the target device of the controller according to the embodiment. As shown in FIG. 17, the device controller 115 first acquires the current history information or the nearest predetermined period of history information, the control rules and the operating parameter values (step S14). Here, the operating parameter values acquired by the device controller 115 are the optimum operational parameter values for the control rules, which are selected by the above learning processing and stored in the operating parameter value table 116.

Next, the device controller 115 selects one rule from among the control rules acquired (step S15). The device controller 115 determines whether the history information satisfies the control start condition of the selected control rule to thereby determine whether to start control in accordance with the control rule (step S16). When the device controller 115 determines not to start control (No in step S16), it determines whether the processes are finished or not on all of the control rules (step S18). When the processes are finished on all of the control rules (Yes in step S18), the device controller 115 finishes the processing, and when unprocessed control rule exist (No in step S18), it selects next control rule (step S15).

On the contrary, when the device controller 115 determines to start control in accordance with the selected control rule (Yes in step S16), it sends control content of the control rule and the optimum operating parameter value corresponding to the control rule to the target device and starts control on the target device (step S17). Thus, the device controller 115 sets the operational parameter of the target device to the optimum operating parameter value. The controller according to the embodiment executes the above-mentioned control processing at the predetermined interval such as several seconds, one minute, or the like.

As explained above, the controller according to the embodiment can control the target device automatically using the optimum operating parameter value. This enables the user to construct comfortable environment or enjoy a merit of reduction of power consumption, and the like without adjusting the operating parameter value of the target device by the user themselves. Furthermore, even when the change on tendency of the user occurs, the controller can control the target device using the optimum operating parameter value according to the change since the optimum operating parameter value is updated automatically by the learning processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An operational parameter value learning device which learns an operational parameter value of a device for each of users:
a calculator being configured to calculate a duration time during which the device is estimated to have operated at each operational parameter value for each of the users based on history information including at least one of: behavior states of the users, an environmental state, and an operational state of the device; and
a selector configured to calculate a continuation probability feature amount according to which the device continues an operation at each operational parameter value in each duration time for each of the users on a basis of the duration time calculated by calculator and selects the operational parameter value based on the calculated continuation probability feature amount.

2. The operational parameter value learning device according to claim 1, wherein
the calculator compares an applied condition with the history information, the applied condition being set based on at least one of: behavior states of the users, an environmental state, and an operational state of the device, and
calculates the duration time during which the history information satisfies the applied condition for each user and each operational parameter value.

3. The operational parameter value learning device according to claim 1, wherein
the calculator compares the history information with a start condition to acquire a start time at which the history information satisfies the start condition, compares the history information with an end condition to acquire an end time at which the history information satisfies the end condition, and calculates the duration time based on the start time and the end time.

4. The operational parameter value learning device according to claim 3, wherein
the end condition includes that a threshold time elapse s on or after the start time.

5. The operational parameter value learning device according to claim 3, wherein
the end condition includes that the operational parameter value changes on or after the start time.

6. The operational parameter value learning device according to claim 3, wherein
the end condition includes a first end condition and a second end condition,
the first end condition includes that the operational parameter value changes so as to improve availability by the target device and
the second end condition includes at least either one of: the operational parameter value changes so as to lower the availability by the target device or a threshold time elapses on or after the start time.

7. The operational parameter value learning device according to claim 1, wherein
the selector selects the operational parameter value at which the energy consumption of the device is lowest, the operational parameter value at which the continuation probability feature amount is largest, or the operational parameter value nearest to a current operational parameter value.

8. The operational parameter value learning device according to claim 1, further comprising
an information acquirer configured to acquire the history information.

9. The operational parameter value learning device according to claim 1, wherein
the operational parameter of the device includes a set temperature of a heating and cooling device, an air volume thereof, an air direction thereof, and illuminance of a lightning device.

10. The operational parameter value learning device according to claim 1, wherein
a notifier configured to notify the selected operational parameter value to the user.

11. A learning-type device controller,
the operational parameter value learning device of claim 1;
a controller configured to control the device by the operational parameter value selected by the operational parameter value learning device.

12. An operational parameter value learning method, which learns an operational parameter value of a device for each of users, comprising:
calculating a duration time during which the device is estimated to have operated at each operational parameter value for each of the users based on history information including at least one of: behavior states of the users, an environmental state, and an operational state of the device; and
calculating a continuation probability feature amount according to which the device continues an operation at each operational parameter value in each duration time for each of the users on a basis of the duration time calculated by calculator and selecting the operational parameter value based on the calculated continuation probability feature amount.
